(19) United States
(12) Patent Application Publication
(10) Pub. No.: US 2010/0329689 A1
(43) Pub. Date: Dec. 30, 2010

(54) RF REMOTE-CONTROL DEVICE CAPABLE OF REMOTELY CONTROLLING A PLURALITY OF PIECES OF IR EQUIPMENT AND REMOTE CONTROL METHOD THEREOF

(76) Inventor: Kwong Sang SIN, Tai Po (HK)

Correspondence Address: OSTROLENK FABER GERB & SOFFEN, 1180 AVENUE OF THE AMERICAS, NEW YORK, NY, 100368403, US

(21) Appl. No.: 12/617,285

(22) Filed: Nov. 12, 2009

(30) Foreign Application Priority Data
Jun. 25, 2009 (CN) 200910031789.6

(51) Int. Cl. H04B 10/00; G08C 19/12

(52) U.S. Cl. 398/115; 341/176

(57) ABSTRACT

Disclosed are an RF remote-control device is capable of remotely controlling a plurality of pieces of IR equipment and an RF remote control method. A remote-control device upgrades IR remote-control equipment for RF remote control. A “unified” control method remotely-controls a plurality of pieces of IR equipment using one remote controller. An RF remote controller includes a key device, an MCU 1 and its control circuit, and an RF signal module 1. An RF-IR converter comprises an RF signal module 2, an MCU 2 and its control circuit. An IR transmitting circuit is capable of transmitting infrared signals. The RF signal module 1 corresponds to the RF signal module 2, and the IR transmitting circuit corresponds to the IR equipment. The method is realized mainly by the steps: 1) pairing; 2) pre-storing IR code data; 3) placing; and 4) operating. In order to make the remote control of a plurality of pieces of equipment omnidirectionally and trouble free, the remote controllers of the plurality of pieces of equipment are unified into an RF remote controller and an RF-IR converter. An operator can carry out the remote control of the plurality of pieces of equipment omnidirectionally and trouble free by operating the RF remote controller.

### CROSS REFERENCE TO RELATED APPLICATION

The present application claims priority of Chinese application 200910031789.6, filed Jun. 25, 2009, incorporated by reference herein.

### TECHNICAL FIELD

The present invention relates to a remote-control device for upgrading IR remote-control equipment for RF remote control and, also to a “unified” control method for remote-controlling a plurality of pieces of IR equipment using one remote controller.

### BACKGROUND ART

The application of IR in household entertainment appliances has a long history, and the remote controllers of many TV, DVD and audio systems are all infrared remote control units (IR RCUs). Each one of the household electric appliances is equipped with an IR RCU, and when the household electric appliance needs to be controlled, the special IR RCU of the household electric appliance has to be used. This leads to requiring numerous remote controllers and tedious operations, and the remote controllers need to be changed in order to control various household electric appliances.

Meanwhile, although IR RCUs are advantageous in terms of their low costs and a wide range of applications, there are many problems in their use. For example: 1. since the transmission angle of IR is relatively narrow and the receiving distance is limited, a remote controller cannot be used by people pointing it in any direction desired; and 2. since IR undergoes serious interference when used in sunlight, IR remote control units cannot normally be used outdoors.

### DESCRIPTION OF THE EMBODIMENT

The present invention is aimed at overcoming defects in the prior art. It provides an RF remote-control device for upgrading the IR remote-control equipment for RF remote control, with only one remote controller to control a plurality of pieces of equipment. The invention also concerns a method of using remote control.

The RF remote-control device of the present invention comprises an RF remote controller and an RF-IR converter. The RF remote controller comprises a key device, an MCU 1 and its control circuit, and an RF signal module 1. The RF-IR converter comprises an RF signal module 2, an MCU 2 and its control circuit, and an IR transmitting circuit capable of transmitting infrared signals. The RF signal module 1 corresponds to the RF signal module 2, and the IR transmitting circuit corresponds to said IR equipment.

The remote control method performed by the RF remote-control device of the present invention realizes the remote control of the IR equipment by the steps as follows:

1) pairing: pairing the RF remote controller and the RF-IR converter to enable them to communicate with each other;

2) pre-storing IR code data: having the RF-IR converter preloaded with an IR code database which is wider than the IR code data of the plurality of pieces of IR equipment;

3) placing: placing the RF-IR converter adjacent to the IR equipment to be controlled, to enable the controlled equipment to receive an IR signal sent by the RF-IR converter; and

4) operating: pressing the key device of the RF remote controller to operate a corresponding function, wherein the RF remote controller sends an RF signal of the key to the paired RF-IR converter. The RF-IR converter analyzes and decodes the RF signal, converts it into the IR signal of a corresponding piece of set equipment, and sends the IR control signal to the controlled equipment via the IR transmitting circuit to perform a corresponding action. At the same time, the RF signal module 2 feeds the received signal back to the RF signal module 1, informing the remote controller that a correct instruction has been received; and the RF remote controller sends a stop signal to stop working upon receiving the feedback signal.

In the present invention, in order to make a plurality of pieces of equipment remotely controlled omnidirectionally and trouble free, the remote controllers of a plurality of pieces of equipment are unified into one RF remote controller and an RF-IR converter. An operator can realize remote control of a plurality of pieces of equipment omnidirectionally and trouble free by operating the RF remote controller. In order to accomplish the above-mentioned effects, the first problem to be solved is that the remote-control device has the ability to send IR codes capable of covering all the functions of all the equipment; then, according to a user's will, by the operation of the key operating device of the RF remote controller, one setting operation is performed for one piece of equipment and is accurately carried out. The present invention improves the distance and omnibearing behavior of conventional IR RCUs by a system that converts an IR RCU into an RF linking system, and can make all the existing equipment using IR technology compatible by converting RF signals into IR codes. The existing IR-based equipment can still be controlled while an RF RCU is used (thus enjoying the advantages brought about by the omnibearing RCU).

### BRIEF DESCRIPTION OF THE DRAWINGS

FIG. 1 is a block diagram of an embodiment of the present invention

FIG. 2 is a block diagram of an embodiment of the RF remote controller of the present invention

FIG. 3 is a block diagram of an embodiment of the RF-IR converter of the present invention

### DESCRIPTION OF PREFERRED EMBODIMENTS

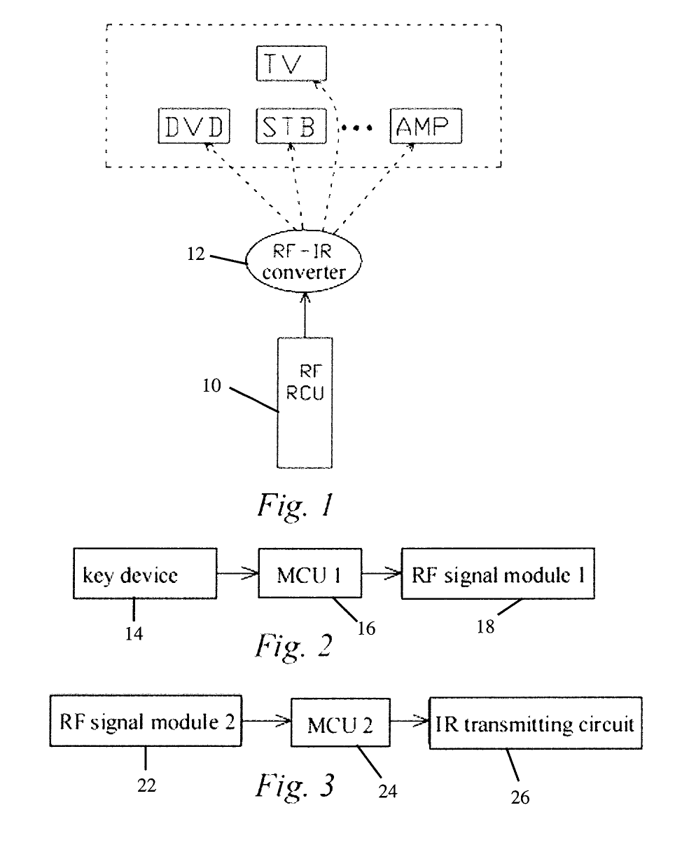

The RF remote controller of the present invention is capable of remotely controlling a plurality of pieces of IR equipment is shown in FIGS. 1-3. It comprises an RF remote controller RCU 10 and an RF-IR converter 12. The RF remote controller 10 comprises a key device 14, an MCU 1, 16 and its control circuit, and an RF signal module 1, 18. The said RF-IR converter comprises an RF signal module 2, 22 an MCU 2, 24 and its control circuit, and an IR transmitting circuit 26 capable of transmitting infrared signals. The RF signal module 1, 18 corresponds to the RF signal module 2, 22 and the IR transmitting circuit 26 corresponds to the IR equipment.

The remote control method of the RF remote-control device of the present invention is operative for the remote control of the IR equipment by the steps as follows:

1) pairing: pairing the RF remote controller and the RF-IR converter to enable them to communicate with each other;

2) pre-storing IR code data: having the RF-IR converter preloaded with an IR code database which is wider than the IR code data of the plurality of pieces of IR equipment;

3) placing: placing the RF-IR converter adjacent to the IR equipment to be controlled, so as to enable said controlled equipment to receive an IR signal sent by the RF-IR converter; and

4) operating: pressing the key device of the RF remote controller to operate a corresponding function. The RF remote controller sends an RF signal of the key to the paired RF-IR converter. The RF-IR converter analyzes and decodes the RF signal, converts it into the IR signal of a corresponding piece of set equipment, and sends the IR control signal to the controlled equipment via the IR transmitting circuit to perform a corresponding action. At the same time, the RF signal module 2 feeds the received signal back to the RF signal module 1, informing the remote controller that a correct instruction has been received; and the RF remote controller sends a stop signal to stop working upon receiving the feedback signal.

When a user presses a selected key of the RF remote controller, a set of RF command information packages will be transmitted to a destination address. The converter, having a precise destination address, will analyze the command information packages, thereby identifying which one of the keys has been pressed.

Then a suitable IR code (and also including a pre-determined setting number) is found and transmitted.

Thereby, the IR code can control the destination equipment.

It should be noted that in view of the lifetime of the battery of the RF-IR converter, the converter needs to be as energy-saving as possible. Therefore, there will be a lag of 220 mS (a head code of 220 mS will be transmitted by the RF remote controller) to order the RF-IR converter to activate ready for operation.

The RF remote controller will not transmit this head code within the following 8 seconds.

The RF-IR converter will have a periodic activation of 220 mS to detect the carrier frequency, and this will be maintained for 10 seconds until the last set of data packages is received. In this way, the amount of current consumed will be reduced to a great extent.

The adoption of a one-way transmission protocol can reduce the effective loads and the complexity of the MCU hardware, while the two-way RF transmission protocol will guarantee the effective reception of the receiving hardware. The present invention employs the two-way transmission protocol to ensure the key signals have been received by the RF-IR converter.

The equipment of the present invention can allow a plurality of RF-IR converters to coordinate in a cooperative task at the same time. This avoids possible IR conflict by use of a plurality of RF-IR converters in operation. In this way, a plurality of RF-IR converters can be placed in various operational environments. Since some pieces of the IR equipment may be placed at relatively hidden or dispersed locations, one converter cannot ensure that all the IR equipment is receiving the IR signals transmitted by the converter. This makes the RF remote control capable of being used effectively.

The ID of each remote controller or converter is unique. Only when the destination ID of a converter in an information package is correct, then the remote controller can pair with the converter. The converter can also identify the source ID (the RF remote controller ID) and additionally, the converter will ignore the RF information packages of the non-destination addresses. The format of an RF information package may be as in the following table:

| | | Source | Destination | Length | | | |
|---|---|---|---|---|---|---|---|
| Head code | Fixed code | address | address | of data | Command code | Data bit | Check bit |
| AA AA | 43 47 | 32 bits | 32 bits | 8 bits | 8 bits | Variable length | 16 bits |

Various RF data packages are used in the communication between the remote controller and the converter, and in this system, the RCU will transmit a command to the converter, and the converter will respond to this, namely, the converter will not initiate communication.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An RF remote-control device configured for remotely controlling a plurality of pieces of IR equipment, the device comprising an RF remote controller and an RF-IR converter;
the RF remote controller comprises a key device, an MCU 1 and a respective first control circuit of the MCU 1, and an RF signal module 1;
the RF-IR converter comprises an RF signal module 2, an MCU 2 and a respective second control circuit of the MCU 2, and an IR transmitting circuit configured to transmit infrared signals; and
the RF signal module 1 corresponds to the RF signal module 2, and the IR transmitting circuit corresponds to the IR equipment.

2. A method for remote-control of an RF remote-control device according to claim 1, comprising remotely controlling the IR equipment by the following steps:
(1) pairing the RF remote controller and the RF-IR converter to communicate with each other;
(2) pre-storing IR code data by preloading the RF-IR converter with an IR code database which is wider than IR code data of said plurality of pieces of IR equipment;
(3) placing the RF-IR converter sufficiently adjacent to the IR equipment to be controlled, to enable the controlled equipment to receive an IR signal sent by the RF-IR converter;
(4) operating the key device of the RF remote controller to operate performance of a corresponding function, wherein the RF remote controller sends an RF signal of the key to the paired RF-IR converter, the RF-IR converter analyzes and decodes the RF signal, converts the RF signal into an IR signal of a corresponding piece of set equipment, and sends the IR control signal to the controlled equipment via the IR transmitting circuit to cause the equipment to perform a corresponding action;
(5) at the same time, the RF signal module 2 being configured to feed the received signal back to the RF signal module 1 for informing the remote controller that a correct instruction has been received; and the RF remote controller sends a stop signal to stop the remote controlling upon receiving the feedback signal.
